(19) United States
(12) Patent Application Publication
(10) Pub. No.: US 2020/0275616 A1
(43) Pub. Date: Sep. 3, 2020

(54) ADJUSTABLE TWIG BENDER

(71) Applicants: HSUEH-FENG LIAO, Taichung City (TW); REN-CHAO LIAO, Taichung City (TW)

(72) Inventors: HSUEH-FENG LIAO, Taichung City (TW); REN-CHAO LIAO, Taichung City (TW)

(21) Appl. No.: 16/288,849

(22) Filed: Feb. 28, 2019

(51) Int. Cl. A01G 17/10; A01G 13/00

(52) U.S. Cl. CPC A01G 17/10; A01G 13/00

(57) ABSTRACT

An adjustable twig bender is made of a metal wire. The adjustable twig bender includes two hooking sections extending from two ends of a bridging section. The hooking sections substantially extend in a same direction. In use, the hooking sections are engaged with two portions of a twig and the bridging section is wound around the twig.

### BACKGROUND OF INVENTION

### 1. Field of Invention

The present invention relates to gardening apparatus and, more particularly, to an adjustable twig bender for gardening.

### 2. Related Prior Art

In the growth of a plant, twigs tend to extend upward against the gravity and because of phototaxis. Twigs can be forced to extend downward or a desired direction in a twigging process. Nutrition tends to accumulate at a tip of a twig that extends downward because of gravity. Hence, fruit that grows at the tip of the twig tends to be big.

A plastic, cotton or non-woven rope or strip can be used to adjust the direction of the extension of a twig in a twigging process. A section of the rope or strip is tied to the twig and another section of the rope or strip is tied to the ground or a weight for example. Thus, the twig is bent and extends downward. This process demands a lot of labor and exhibits a low efficiency. Moreover, the twig could be released prematurely from the rope or strip if the rope or strip is broken soon. The twig could be strangled by the rope or strip and broken by wind if the rope or strip lasts long.

Referring to FIGS. 4 and 5, a twig-bending clip 90 is used in twigging. The twig-bending clip 90 includes two jaws between which a bent passageway 92 is defined. A twig 80 is inserted and then kept in the bent passageway 92 so that the twig-bending clip 90 bends the twig 80.

However, the use of the twig-bending clip 90 is not without any problem. Firstly, the twig-bending clip 90 clips a short section of the twig 80 such as a water sprout so that the twig 80 is bent sharply. Such sharp bending could snap the twig 80.

Secondly, a transverse size of the bent passageway 92 of the twig-bending clip 90 is fixed. The twig-bending clip 90 might slip from the twig 80 if the transverse size of the bent passageway 92 is much larger than a transverse size of the twig 80. On the contrary, the twig-bending clip 90 could not clip the twig 80 in the first place if the transverse size of the bent passageway 92 is much smaller than the transverse size of the twig 80.

Thirdly, the twig-bending clip 90 is made of plastics and could easily be jeopardized by ultraviolet light. Such a jeopardized twig-bending clip 90 is useless and becomes garbage that cannot be decomposed.

Fourthly, the twig-bending clip 90 is expensive.

The present invention is therefore intended to obviate or at least alleviate the problems encountered in prior art.

### SUMMARY OF INVENTION

It is the primary objective of the present invention to provide an inexpensive, reliable and adjustable twig bender.

To achieve the foregoing objective, the twig bender is made of a metal wire. The twig bender includes two hooking sections extending from two ends of a bridging section. The hooking sections substantially extend in a same direction. In use, the hooking sections are engaged with two portions of a twig and the bridging section is wound around the twig.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a front view of an adjustable twig bender according to the preferred embodiment of the present invention;

FIG. 2 is a front view of the adjustable twig bender of FIG. 1 in a position for bending a twig;

FIG. 3 is a front view of the adjustable twig bender in another position than shown in FIG. 2;

FIG. 4 is a perspective view of a conventional twig-bending clip; and

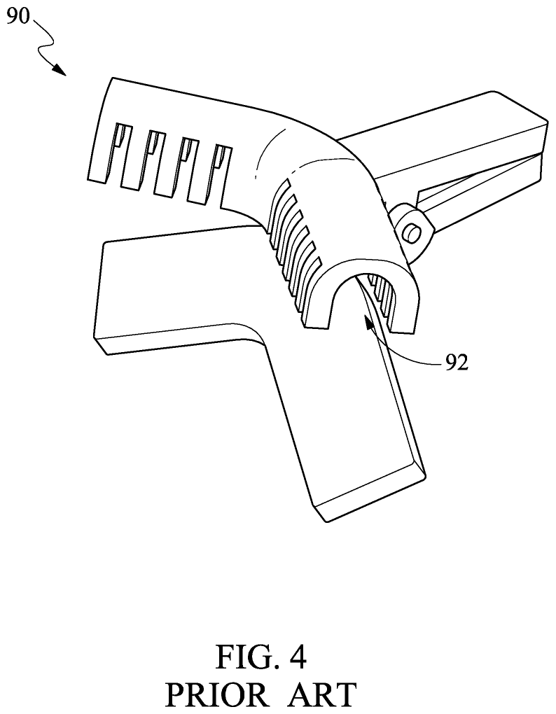

FIG. 5 is a cross-sectional view of a twig clipped by the adjustable twig-bending clip shown in FIG. 4.

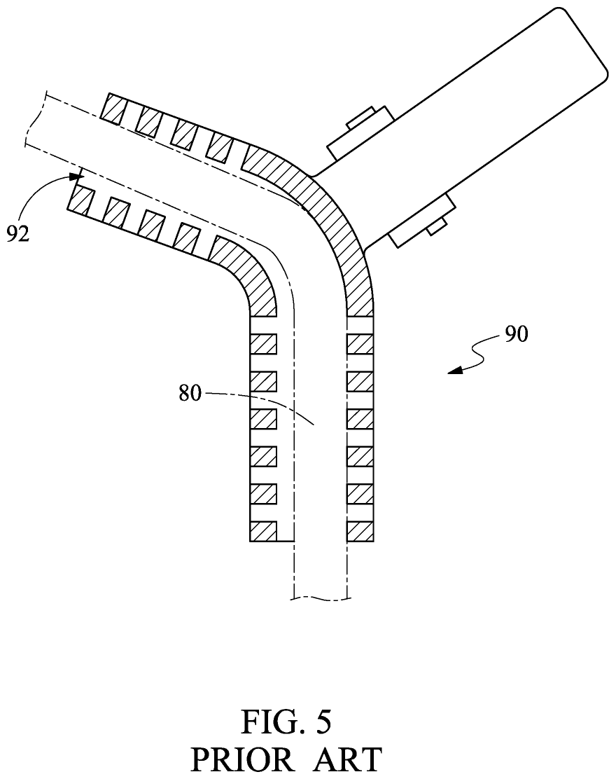

### DETAILED DESCRIPTION OF PREFERRED EMBODIMENT

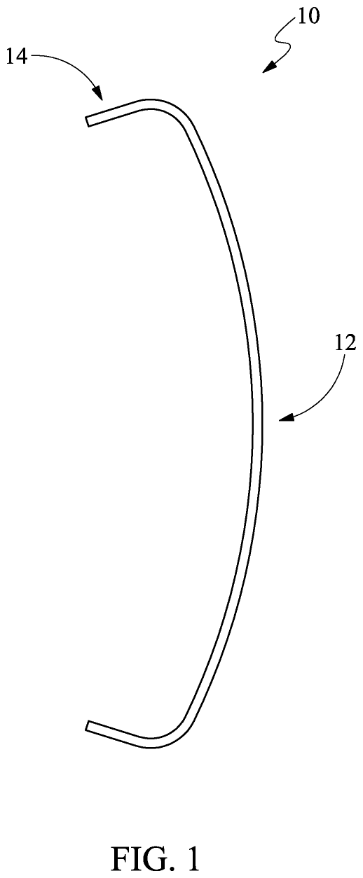

Referring to FIG. 1, an adjustable twig bender 10 includes a bridging section 12 and two hooking sections 14 according to the preferred embodiment of the present invention. The adjustable twig bender 10 is preferably made of a metal wire that exhibits proper flexibility and rigidity. The proper flexibility allows the adjustable twig bender 10 to be bent by a torque. The proper rigidity allows the adjustable twig bender 10 to remain in shape after it is released from the torque.

Preferably, the bridging section 12 extends along an arc. Alternatively, the bridging section 12 extends rectilinearly.

The hooking sections 14 are formed at two opposite ends of the bridging section 12. The hooking sections 14 extend substantially in a same direction.

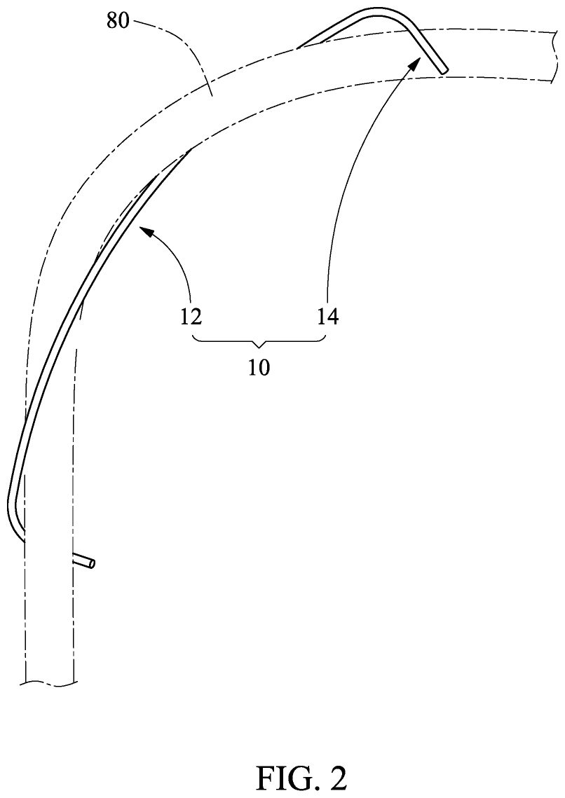

Referring to FIG. 2, at first, one of the hooking sections 14 is engaged with a portion of a twig 80. Then, the bridging section 12 is wound around the twig 80. Finally, the other hooking section 14 is engaged with another potion of the twig 80. Now, two portions of the twig 80 are engaged with the hooking sections 14, and at least two other portions of the twig 80 are in contact with the bridging section 12. Thus, twig 80 is bent and forced to extend in a desired direction. As mentioned above, the proper flexibility allows the bridging section 12 to be bent and wound around the twig 80. The proper rigidity allows the adjustable twig bender 10 to keep bending the twig 80.

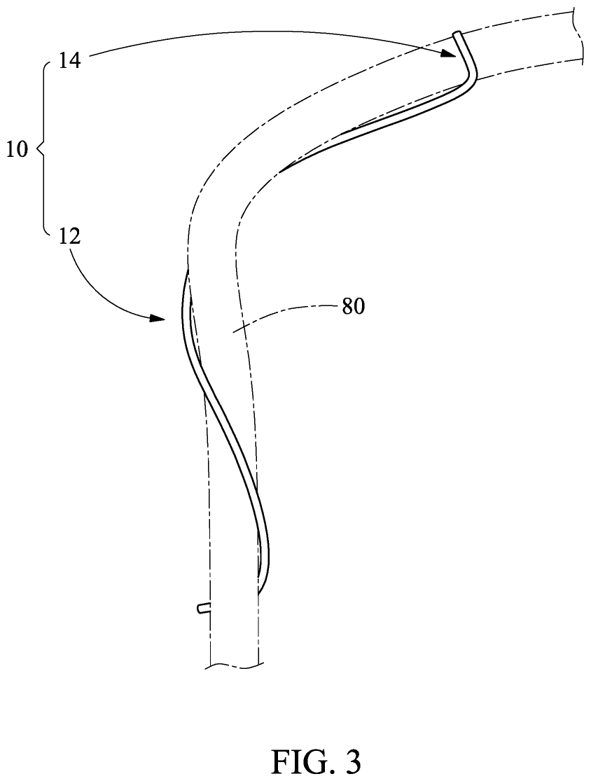

Referring to FIG. 3, the bridging section 12 is further bent, and so is the twig 80. Thus, twig 80 can be bent and forced to extend in desired direction.

The bridging section 12 is properly long. Thus, the section of the twig 80 between the portions of the twig 80 engaged with the hooking sections 14 of the adjustable twig bender 10 is properly long. Hence, the twig 80 is bent mildly and will not be broken.

The use of the adjustable twig bender 10 exhibits several advantages. Firstly, the adjustable twig bender 10 bends and forces the twig 80 to extend in a desired direction since the bridging section 12 is made with proper flexibility and rigidity.

Secondly, the cost of using the adjustable twig bender 10 is low. The adjustable twig bender 10 can be removed from the twig 80 after 3 to 8 months when the shape of the twig 80 is permanently fixed. Then, the adjustable twig bender 10 can used to bend another twig.

Thirdly, the adjustable twig bender 10 controls the growth of a fruit tree such as the height and a horizontal size of the fruit tree. To control the growth of the fruit tree, twigs that extend upward are cut or bent. The adjustable twig bender 10 bends such twigs and hence controls the growth of the tree. With the height of the fruit tree kept at a proper value, fruit can be collected easily. With the horizontal size of a fruit tree kept at a proper value, leaves of the fruit tree spread in a large area and receive a large amount of sunlight so that photosynthesis in the leaves is adequate and that sweetness in the fruit is adequate.

Fourthly, the adjustable twig bender 10 facilitates the growth of the fruit. The adjustable twig bender 10 bends and forces the twig 80 to extend downward. Thus, the fruit dangles from the twig 80. That is, no portion of the fruit except a stem is in contact with the twig 80 so that the fruit tends to grow in a good shape and at a large amount.

Fifthly, the adjustable twig bender 10 limits a reflux ratio in the twig 80. The hooking sections 14 abut against two portions of the twig 80 and the bridging section 12 abuts against at least two portions of the twig 80, thereby preventing reflux of sap along the twig 80. Hence, nutrition accumulates in the fruit and the fruit grows well.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. An adjustable twig bender made of a metal wire and comprising a bridging section (12) and two hooking sections (14) extending from two ends of the bridging section (12), wherein the hooking sections (14) substantially extend in a same direction, and the hooking sections (14) are engaged with two portions of a twig and the bridging section (12) is wound around the twig in operation.

2. The adjustable twig bender according to claim 1, wherein the bridging section (12) extends along an arc.
